(19) United States
(12) Patent Application Publication
(10) Pub. No.: US 2013/0320167 A1
(43) Pub. Date: Dec. 5, 2013

(54) Method for Hanging Signs and Mounting Device

(71) Applicants: Bo Karlsson, Torslanda (SE); Niclas Hedell, Hoviksnas (SE)

(72) Inventors: Bo Karlsson, Torslanda (SE); Niclas Hedell, Hoviksnas (SE)

(73) Assignee: BO FASTENING AB, Västra Frölunda (SE)

(21) Appl. No.: 13/985,167

(22) PCT Filed: Feb. 8, 2012
(86) PCT No.: PCT/EP2012/052131

§ 371 Date: Aug. 13, 2013

(30) Foreign Application Priority Data
Feb. 14, 2011 (SE) 1100098-1

(51) Int. Cl. G09F 7/18

(52) U.S. Cl. CPC G09F 7/18
USPC 248/223.41

(57) ABSTRACT

A mounting device (100′, 100″) for attachment to a spotlight rail (101), having a planar surface adjacent to a ferromagnetic material and designed so that it will face downward after the attachment and has a diameter greater than the entrance width of the spotlight rail. At a distance from the ferromagnetic surface, attached thereto via a stem, there are two opposite wings, the width of which is smaller than the entrance width of the spotlight rail (101) and the largest diameter of which is greater than the entrance width of the spotlight rail. The diameter of the stem is smaller than the entrance width of the spotlight rail (101), but has a protruding portion that prevents rotation by more than a quarter of a turn after insertion into the spotlight rail. The mounting device is part of a system for hanging signs (102) in business premises where the signs are hung with a magnet. The mounting device can safely be inserted into and attached to a spotlight rail without having to use a ladder. The need for a special sign hanging rail is eliminated, since the spotlight rail is used both for lighting and sign hanging.

### TECHNICAL FIELD

The present invention relates to a method for hanging signs at a distance from a ceiling. A special mounting device allows, for example, advertising or information signs to be hung or changed in rooms with large ceiling height, without necessitating any lifting platform or other lifting device, and at the same time eliminates electrical safety hazards.

### BACKGROUND OF THE INVENTION

Different types of advertising and information signs are commonly occurring, for example in department stores and in building material stores. In addition to advertising, the signs may, for example, display way descriptions, information about the assortment of products, or price information to make purchases easier for the customers. It is advantageous if the signs can be installed hanging from the ceiling, since this saves floor space and does not obstruct the passage of customers through the room. One problem of such a suspension from the ceiling, however, is the large ceiling height, which can often exceed 6 metres. For safety reasons, work at such great heights has to be performed by means of a lifting platform or another suitable lifting device. In a store, where at least some signs are changed daily, the use of a lifting platform is very inconvenient.

A previously known way of facilitating the hanging of signs in rooms with large ceiling height is to suspend a stationary sign hanger at a lower height, e.g. 3.5 metres from the ceiling, by means of a lifting platform, and to then hang the desired signs on the stationary sign hanger manually. A stationary sign hanger hung at such a lower height allows workers to hang or change signs by means of a step ladder or the like. The signs are hung from the stationary sign hanging rail by means of a steel wire bent into a hook, which is hung around the rail.

In shops and department stores, there is also a need for lighting that can be directed toward displayed goods and other display arrangements. So called spotlight rails is a common way of providing a flexible lighting system. These can consist of an aluminium profile, containing electrical conductors insulated from the aluminium profile. The profile is open downward so that a spotlight can be inserted and make contact with the electrical conductors. Thereafter, the spotlight is directed toward the object that is to be illuminated and is turned on by current supply from the conductors in the spotlight rail.

The spotlight rails are hung from the ceiling by means of suspension wires of an appropriate length, so that the spotlights are set at a suitable height, e.g. 2.5-4 m from the floor. Several aluminium profiles can be joined together in a row to form long, continuous spotlight rails passing through the room at a suitable height above the floor.

A serious problem found in stores where workers are busy hanging signs is that the rails in the ceiling are mixed up. The steel wire hook is lifted to the spotlight rail and makes contact with the conductors inside it and the person gets a life-threatening electrical shock.

### SUMMARY OF THE INVENTION

The invention seeks to solve the problem and eliminate the electrical safety hazard, to lower the costs of the installations in the store, and to make the sign hanging work more effective.

The essential part of the invention is a mounting device for hanging signs from the spotlight rail. The mounting device consists of a device made of insulating plastic for insertion into and attachment to the spotlight rail, and is provided with a downwardly directed metal surface capable of receiving a magnet.

The lowering of the costs of the installations in the store is achieved in that the stationary sign hanging rail is not needed, since the spotlight rail can be used for hanging the signs.

The increased efficiency of the work with the signs is achieved in that the mounting device is designed so that it can be connected to a telescopic plastic pole (insulating) to allow the workers to insert the mounting device into the spotlight rail and attach it thereto from the floor. The same or a similar plastic pole is then used to lift and attach a magnet together with the sign hanger to the metallic surface on the mounting device. The method eliminates the need for ladders, and thereby the risk of falling from a ladder. When the accident statistics are studied, this risk cannot be considered negligible.

The electrical safety hazards are eliminated in that the mounting device and the associated tool are made of insulating plastic, and in that the magnet is given such a size and design that it cannot enter the spotlight rail, and also that the associated tool is made of insulating plastic.

Other objects and advantages of the present invention will be evident from the following description.

### BRIEF DESCRIPTION OF THE DRAWINGS

In the following, the invention will be described more closely, only as examples and with reference to the accompanying schematic drawings, in which:

FIG. 1 is a schematic illustration of two mounting devices in use, one attached to the spotlight rail with a sign hanging below it, and one illustrating how it is lifted and attached to the rail by means of a tool;

FIG. 2a shows a schematic perspective view of the mounting device, as seen obliquely from above;

FIG. 2b shows a schematic perspective view of the mounting device, as seen obliquely from below;

FIG. 3a shows an example of the cross-section of a spotlight rail to which the mounting device can be attached;

FIG. 3b shows the maximum area of a cross-section of the stem of the mounting device;

FIG. 4 shows a tool in use for hanging a sign;

FIG. 5 shows an alternative sign hanger according to a previous patent application by the present inventor.

### DETAILED DESCRIPTION OF THE INVENTION

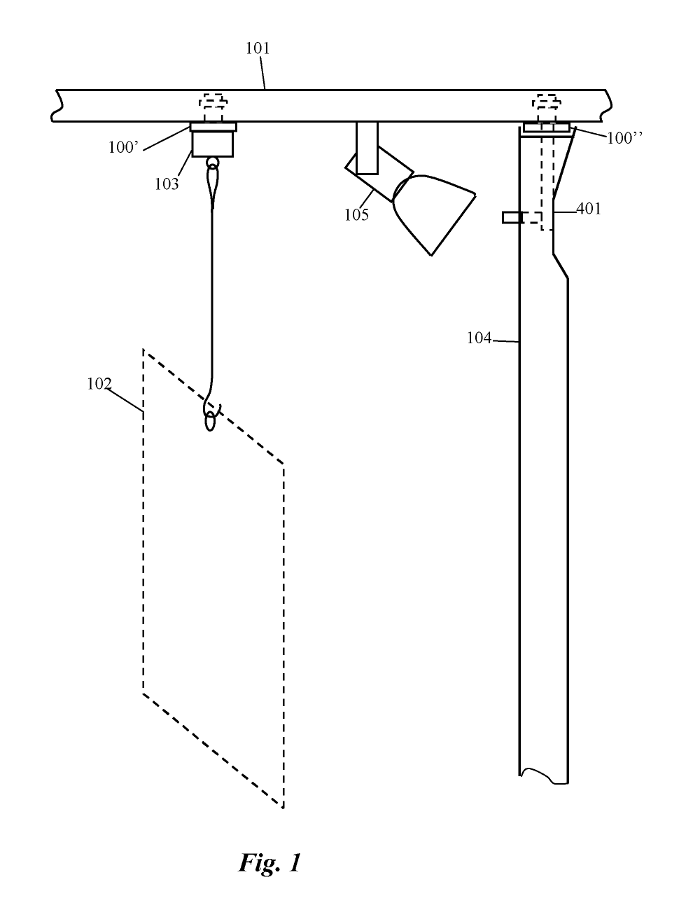

FIG. 1 is a schematic illustration of two mounting devices 100 according to the invention, in a spotlight rail 101. One mounting device 100′ is attached to the spotlight rail 101, with a sign 102 attached by a magnet 103 to the mounting device, and the other one 100″ is in the process of being attached to the spotlight rail held by a tool on a pole 104 for attachment. A spotlight 105 attached to the rail is also shown for clarification. The hanging device 104 is a long pole, with a tool at the upper end having a holder for the mounting device at the top. The pole is long enough to allow workers to stand on the floor and reach up to the spotlight rail, to insert the mounting device into the rail, and to then rotate the pole with the mounting device a quarter of a turn to make it attach to the rail.

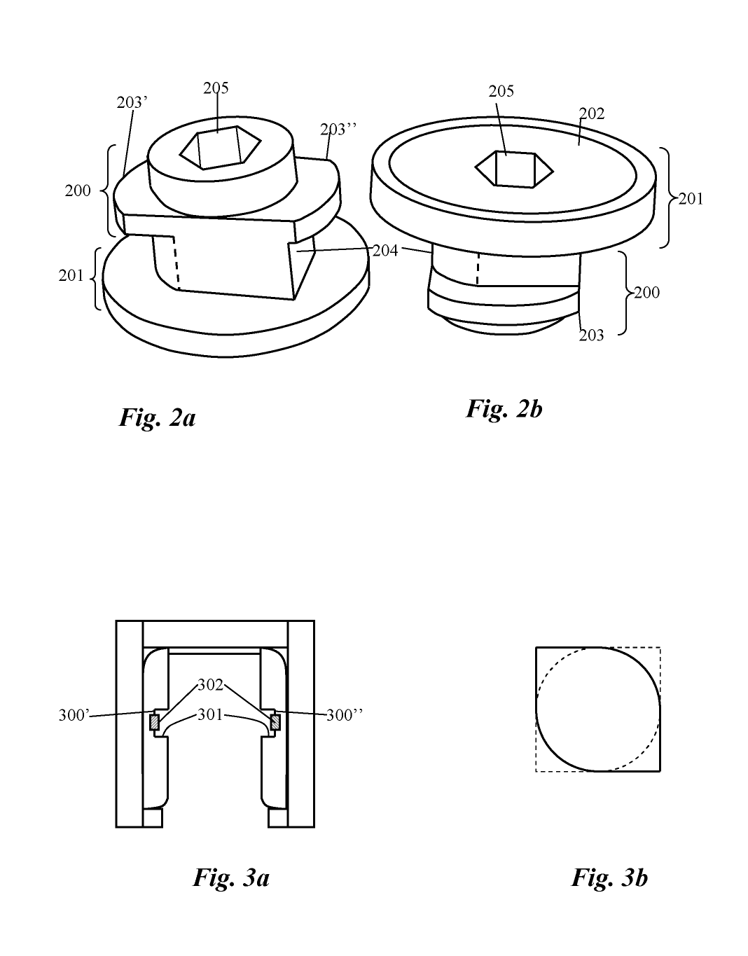

FIG. 2 shows the mounting device according to the invention. FIG. 2a shows it obliquely from above and FIG. 2b obliquely from below. It consists of a top portion 200 intended for attachment to the spotlight rail and a bottom portion 201 for forming a magnetic attachment surface. It is mainly made of insulating plastic, but it also contains some ferromagnetic material, preferably iron or steel, which is inexpensive.

The bottom portion 201 is designed as a circular plate. The most important thing is that it is flat at the bottom, without any objects projecting below the planar surface where a magnet should be attachable. It is only by close contact that the force can become large enough, so that the magnet can reliably hold the sign in place. If there are protruding parts, the magnet could not connect closely to the attachment surface. Adjacent to the bottom plane of the bottom side, there is a ferromagnetic material. This can be an iron plate or a steel washer 202 moulded into or glued to the bottom portion. The ferromagnetic material can be surface-treated, for example by galvanizing, chromating, phosphating or painting, but it can also be left untreated. However, it is advantageous to treat the material against corrosion during transport, storage and use. Preferably, however, the surface treatment should be thin to provide the greatest possible force toward the magnet. The ferromagnetic material can be glued to the plastic body or be moulded into the plastic body during the injection moulding. If an iron or steel plate is chosen, it should have a thickness of at least 0.5 mm, so that the magnetic saturation in the steel does not limit the magnetic force too much. Furthermore, the area should be larger than 200 mm² (square millimetres) to make the force large enough, but also to make it easier to hit the mark when the workers have to hit the right place with the magnet while using the long pole from the floor.

The top portion 200 of the mounting device is so designed that, in a plane we may call the insertion section, orthogonal to the ferromagnetic plane, it is so narrow that it can be inserted into the spotlight rail, and that, in another plane called the attachment section, orthogonal to both the above-mentioned planes, it has two wings 203, 203′ and 203″, projecting so far that they can attach to the spotlight rail. The wings are fixed on a stem 204 at a distance from the bottom portion. FIG. 2a shows a perspective view of the attachment section and FIG. 2b of the insertion section. The insertion and the attachment of the mounting device is done such that the mounting device is rotated so that the insertion section is visible when looking along the spotlight rail, and the mounting device is inserted into the spotlight rail as far as possible. Thereafter, the mounting device is rotated a quarter of a turn so that instead the attachment section would be visible when viewed from the same viewing angle, if the spotlight rail was not obstructing the view.

To be able to rotate the mounting device, a torque has to be transferred from the tool. This can be done by inserting an appropriate torque transfer means into a non-circular hole in the mounting device. The hole can be a through-hole as in the figure, but it is sufficient that it is open toward the bottom side of the mounting device. An example with a hexagonal hole 205, where a hexagonal torque rod can be inserted and transfer torque (as a socket head key used in a socket head screw), can be seen in the figure. An alternative method for the torque transfer is to instead make the edge of the bottom part non-circular, for example octagonal, so that an appropriate tool enclosing the edge can transfer the torque (as from a socket wrench to a nut) However, the shape of both the external and internal torque transfer means can be chosen non-circular in many alternative ways, for example triangular, quadrangular, pentagonal, hexagonal, heptagonal, octagonal or nonagonal, or be designed as a curve of constant width, or as a spline joint.

The spotlight rail is so designed that it has a longitudinal channel open downward. The opening of the channel has a certain width, called the entrance width. An example of the cross-section of the spotlight rail is shown in FIG. 3a. A small distance into the channel, there is at least one groove 300′ and 300″ on each side, so that a larger width is provided at the grooves. This difference in width creates two edges 301, which are used for the attachment. The wings for the attachment to the rail are fixed on a stem 204, attached to the bottom portion. In the insertion section, the stem and the wings will now have to be narrower than the width of the channel (below the grooves). In the attachment section, the wings have to be so long (i.e. exhibit such a large diameter) that they protrude into the grooves in the channel. However, they must not be so long that they cannot be accommodated. The stem, on the other hand, has to be narrower than the entrance width in both sections. The stem may also continue above the wings. To ensure that the mounting device is fixed without play, the length of the stem below the wings should be so great that that the bottom side of the wings contacts the bottom edge of the grooves after the rotation, when the bottom portion is pressed against the bottom edge of the spotlight rail. Possibly, the bottom side of the wings may be given a slight helical curve shape, so that it is easy to initiate the rotation, but the contact force increases as the rotation continues.

Normally, electrical conductors 302 are placed at the bottom of the grooves. Therefore, the top portion of the mounting device has to be insulating, so that it cannot conduct electricity from the conductors to the workers busy hanging signs. This can most easily be achieved by making the entire upper attachment portion of injection-moulded insulating plastic, for example polyethylene (PE), polypropylene (PP) or ABS, possibly with fibre reinforcement. It is also possible to make it of metal, but then the surface must be insulated to a satisfactory safety level.

From a safety aspect, the bottom portion should be designed large enough so that the ferromagnetic part can in no way make contact with the conductors in the rail. This is preferably done such that the diameter of the bottom portion of the mounting device is made larger than 18 mm, i.e. significantly larger than the width of the channel (the entrance width), which is normally 14 mm. Since the bottom portion is made in one piece with the upper attachment portion, the bottom portion is impossible to insert into the channel.

Another important safety aspect is that the mounting device is so designed that it is provided with a distinct stop to rotation by more than a quarter of a turn. This can advantageously be achieved in that the stem of the mounting device is designed with as cross-section according to FIG. 3b, i.e. as a circle tightly enclosed by a square, wherein two diagonal corners of the square has been removed outside the circle. The circle should have a diameter slightly below the width of the channel, and the diagonal of the square should be more than 120% of the width of the channel, to provide a reliable rotational stop. The angular position of the cross-section of the stem should be such that the stem looks like it has the diameter of the circle both in the insertion section and the attachment section. The angular position of the stem is illustrated in FIGS. 2a and 2b. The stem does not have to fill the entire section, as long it is contained within the outline and projects outside the circle in at least one position. For instance, it can be convenient to make the stem a little narrower in the insertion section, and to give it the full channel width in the attachment section. Thereby, the mounting device becomes easy to insert, but is fixed without play after it has been rotated a quarter of a turn to the attachment position. It is also convenient to make a mark on the bottom portion, to make it possible to verify that the mounting device is in the correct rotational position to be inserted from the floor, but above all, to later be able to check that the mounting device is rotated to the attachment position before hanging a sign.

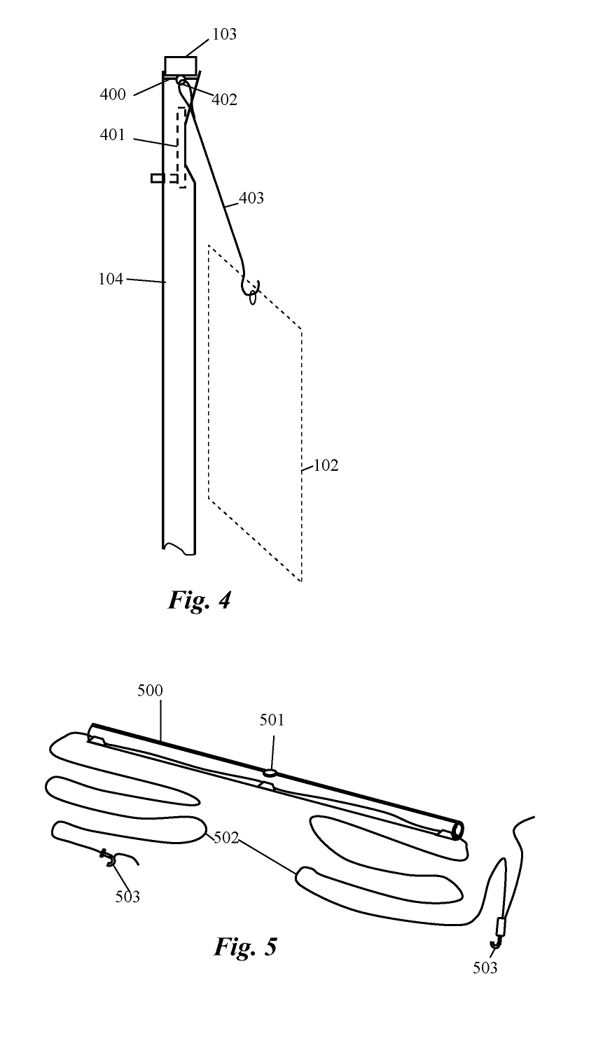

The device for hanging the mounting device consists of a pole with a tool 104 (see FIGS. 1 and 4), with a holder 400 at the top. The holder can be designed as a bowl with just the right size for holding the bottom portion of the mounting device in accordance with FIG. 1. Advantageously, the size of the bottom portion of the mounting device and the magnet are chosen to be the same, so that also the magnet 103 can be held by the tool. This is illustrated in FIG. 4. The tool should be capable of transferring a torque to the mounting device. If the mounting device is designed with a hexagonal hole, a hexagonal torque rod 401 projecting upward from the bowl can provided. In such a case, to be able to place the magnet in the bowl, the hexagonal rod should be retractable. The torque rod is visible in an extended position in FIG. 1 and in a retracted position in FIG. 4. If, instead, the outer edge of the bottom portion of the mounting device is made non-circular, the edge of the bowl must have an appropriate shape, so that the torque transfer takes place via the edge. Furthermore, the bowl must have a notch so that the ring 402 at the bottom side of the magnet and the strapping wire 403 for retaining the sign can exit the bowl to the side of the rod. The pole to which the tool is attached can have a fixed length, or can more advantageously be telescopic so that the length can be adjusted to be just right to reach the spot light rail, which will have different heights in different rooms. Preferably the pole, but above all the tool, is made of plastic to further eliminate all electrical hazards.

FIG. 5 shows an alternative sign hanger according to a previous invention by the same inventor, with application number SE 0901535-5. In this, a rod 500 is attached to the magnet 501. The rod has, at least at each end, a line or a wire 502 of an adjustable length, having a hook 503 at each end. The hooks are intended to be attached to the sign. The length adjustment is used to adjust the height. Since the magnet is attached to the pole, the rotational position of the pole can be used to reliably control the rotational position of the sign. This is very important, since the sign can thus be exhibited to the visitors in a much better way. It is therefore advantageous to use this sign hanger for hanging signs by attaching its magnet to the mounting device.

This sign hanger is defined in that it is a suspension device for suspending objects at a distance from a ceiling, said suspension device comprising at least one rod member and only one flexible suspension line, wherein the rod member is longer than 250 mm and has at least one attachment means for at least one magnetic fastener, and at least one alignment means for slidably suspending an upper portion of the suspension line relative to the longitudinal direction of said rod member, wherein the suspension device further comprises at least one suspension means for connection to both the suspension line and said object, and a length-adjusting device for adjusting the length of the suspension line between said rod member and said suspension means.

### Method for Hanging Signs

The mounting device makes the sign hanging work significantly more effective. In order to hang a sign, the person takes a mounting device 100 according to the invention and the telescopic hanging pole with the tool 104. He extends the telescopic pole to such a length that he can reach up to the spotlight rail. He places the mounting device at the top of the pole tool. He lifts the mounting device up to the rail by means of the tool, adjusts the mounting device to the correct direction, and inserts it into the rail. Then, he rotates the pole with the tool, and thereby the mounting device, a quarter of a turn, and lowers the pole. Thereafter, he takes an attachment magnet to which he attaches the sign, and places the attachment magnet at the top of the tool. He lifts the magnet to the mounting device by means of the pole tool, and “click”, it is attached and the sign stays in place. Now, it only remains to lower the pole, to retract it, and to put it away.

### Advantages

The invention makes the sign hanging work more effective in rooms where both lights and signs are required. Since signs can be hung directly from the lighting rail, there is no need for investing in equipment and installation of special sign holders or hanging rails. The signs can be hung without a ladder or lifting platform. This eliminates the risks associated with climbing on ladders and the need to move things about to provide access for a lifting platform in the room. Only a telescopic pole with a tool will be required for hanging both the mounting device and the signs. The telescopic pole can easily be accommodated into a regular broom closet. Furthermore, the life-threat from the electrical safety hazards is eliminated since no electrically conductive parts of the system can make contact with the electrical conductors in the spotlight rail.

Furthermore, the hanging method according to the invention can be used in other places than in business or office premises, such as in airport terminals, train stations, bus terminals, and other public premises, and then advantageously for hanging information displays, visual display units and similar objects. The mounting device according to the invention can also be used for hanging paintings and other art objects in art galleries or museums.

In the foregoing, a number of embodiments of the invention have been described with reference to the figures in the accompanying drawings. It should be understood that the described embodiments and the details in the figures should only be regarded as examples, and that many other embodiments of the invention are possible within the scope of the following claims.

1.-7. (canceled)

8. A mounting device for attachment to a spotlight rail, comprising:
a ferromagnetic material having a planar surface and configured such that the planar surface faces downward when the mounting device is attached to the spotlight rail, wherein the planar surface has a diameter greater than an entrance width of the spotlight rail; and
opposite wings at a distance from the ferromagnetic material and attached thereto by a stem, wherein a width of the wings is smaller than the entrance width of the spotlight rail; a diameter of a larger one of the wings is greater than the entrance width of the spotlight rail; a diameter of the stem is smaller than the entrance width of the spotlight rail; and the stem has a protruding portion that prevents rotation by more than a quarter of a turn after insertion of the mounting device into the spotlight rail.

9. The mounting device of claim 8, wherein the ferromagnetic material has an area of at least 200 square millimeters.

10. The mounting device of claim 8, wherein the ferromagnetic material includes a plate of iron or steel that is at least 0.5 millimeter thick.

11. The mounting device of claim 8, wherein a portion of the mounting device for insertion into the spotlight rail comprises insulating plastic.

12. The mounting device of claim 8, further comprising a non-circular hole open toward the ferromagnetic material.

13. The mounting device of claim 8, further comprising a non-circular peripheral edge around the ferromagnetic material.

14. The mounting device of claim 8, wherein the stem has a cross-section depicted by a geometrical figure of a circle tightly enclosed by a square, and two diagonal corners of the square have been removed outside the circle.
